(19) United States
(12) Patent Application Publication
(10) Pub. No.: US 2011/0067663 A1
(43) Pub. Date: Mar. 24, 2011

(54) METHOD OF OPERATING ETHANOL FUELLED ENGINES

(76) Inventors: Gordon David Lamb, Berkshire (GB); Simon Philip Gurney, Berkshire (GB); Simon Lewis Renouf, Berkshire (GB)

(21) Appl. No.: 12/736,859

(22) PCT Filed: May 13, 2009
(86) PCT No.: PCT/GB2009/001206

§ 371 Date: Nov. 17, 2010

(30) Foreign Application Priority Data
May 20, 2008 (GB) 08251762.4

(51) Int. Cl. F02B 43/00; C10M 159/24

(52) U.S. Cl. 123/1 A; 508/391

(57) ABSTRACT

A method of operating a compression ignition internal combustion engine which comprises supplying the engine with an aqueous ethanol fuel and lubricating the engine with a lubricating oil composition which mitigates problems of interaction between the oil composition and the fuel, the lubricating oil composition comprising a major amount of a base oil of lubricating viscosity and a minor amount of additives comprising one or more nitrogen-containing dispersant additives and one or more neutral or over-based, metal salt-containing detergent additives, the metal salt-containing detergent additives being present in the lubricating oil composition at a total metal salt concentration in the lubricating oil composition of greater than 0 and up to 1% by weight and the weight ratio of the total amount of nitrogen in the dispersant additives:the total amount of metal salt in the detergent additives being, at least 0.1:1. There is also provided such a lubricating oil composition having a total sulphur content of not greater than 0.44% by weight.

This invention relates to a method of operating a compression ignition, internal combustion engine and to a lubricating oil composition.

Fuels and lubricants may interact in internal combustion engines.

Generally, fuel may ingress into the lubricating oil in the internal engine. A problem with fuel ingressing into the lubricating oil is that it may cause deposits in the lubricant system of the engine.

It is also possible that lubricating oil may ingress into the fuel. For example, it has been found that in compression ignition engines lubricating oil may ingress into the fuel through fuel injector systems. With fuel injector systems having a common rail, lubricating oil may ingress into the fuel in the fuel pump. With fuel injector systems having fuel injectors, lubricating oil may ingress into the fuel in the injectors. A problem with lubricating oil ingressing into the fuel is that it may cause deposits in the fuel system of the engine.

Interaction of fuel and lubricating oil may be a particular problem with aqueous ethanol fuels, especially aqueous ethanol fuels which comprise ignition improver additives. Aqueous ethanol fuels may comprise in solution form, 70 to 96% by weight ethanol and 10 to 2% by weight water. Aqueous ethanol fuels for compression ignition engines may comprise ignition improver additives at concentrations up to 20% weight. Aqueous ethanol fuels may also comprise denaturants for example at concentrations of up to 3% by weight. Examples of denaturants include methyl tert-butyl ether and methanol.

U.S. Pat. No. 5,628,805 relates to an aqueous ethanol fuel in the form of a solution which comprises 70-96% by weight of ethanol, 2-10% by weight of water and 0.5-20% by weight of a water soluble adduct of a polyol having 3-10 hydroxyl groups and ethylene oxide and/or propylene oxide, wherein the molecular weight of the adduct is 350 to 10000.

European patent application EP 0311319 relates to a low sulfated ash heavy duty diesel lubricating oil composition which comprises an oil of lubricating viscosity as the major component and as the minor component (A) at least 3 weight percent of at least one oil soluble ashless dispersant, (B) at least 2 weight percent of at least one oil soluble sulfurized alkyl phenol, and (C) at least one oil soluble metal salt of a dihydrocarbyl dithiophosphate, wherein the lubricating oil is characterized by a total sulfated ash (SASH) level of less than about 0.6 weight percent and by a SASH:dispersant wt:wt ratio of from about 0.01 to about 0.2:1. EP0311319 does not disclose operation of a compression ignition engine with aqueous ethanol fuel.

There is thus a need for a lubricating oil composition which overcomes or at least mitigates these problems.

Thus, according to the present invention there is provided a method of operating a compression ignition engine which method comprises supplying an aqueous ethanol fuel comprising 70 to 96% by weight ethanol, 10 to 2% by weight water and up to 20% by weight ignition improver to the engine and lubricating the engine with a lubricating oil composition which comprises a major amount of a base oil of lubricating viscosity and a minor amount of additives comprising one or more nitrogen-containing dispersant additives and one or more neutral or over-based, metal-salt containing detergent additives, the metal salt-containing detergent additives being present in the lubricating oil composition at a total metal salt concentration in the lubricating oil composition of greater than 0 and up to 1% by weight and the weight ratio of the total amount of nitrogen in the dispersant additives:the total amount of metal salt in the detergent additives being, at least 0.1:1.

It has been found that a lubricating oil composition having a low concentration of metal salt-containing detergent additives and a high ratio of total nitrogen-containing dispersant additives:total detergent metal salt avoids or at least mitigates the problems identified above. Thus, the lubricating oil composition comprises a major amount of a base oil of lubricating viscosity and a minor amount of additives comprising one or more nitrogen-containing dispersant additives and one or more neutral or over-based, metal salt-containing detergent additives, the metal salt-containing detergent additives being present in the lubricating oil composition at a total metal salt concentration in the lubricating oil composition of, greater than 0 and up to 1% by weight and the weight ratio of the total amount of nitrogen in the dispersant additives:the total amount of metal salt in the detergent additives being, at least 0.1:1. In particular, such a lubricating oil composition has a reduced tendency to form deposits when in contact with aqueous ethanol fuel.

The metal salt is sometimes referred to as soap.

The weight ratio of the total amount of nitrogen in the dispersant additives:the total amount of metal salt in the detergent additives in the lubricating oil composition is at least 0.1:1, preferably at least 0.2:1, for example 0.225:1. The weight ratio of the total amount of nitrogen in the dispersant additives:the total amount of metal salt in the detergent additives in the lubricating oil composition may be up to 1:1.

### The Detergent Additives.

The detergent additives in the lubricating oil composition are neutral or over-based, metal salt-containing detergent additives. Generally, the detergent additives will be low soap. The over-based, metal containing detergent additives may have a TBN (total base number as measured by ASTM2896) in the range 100-400 mg potassium hydroxide per kg and preferably in the range 250-400 potassium hydroxide per kg. The metal may be calcium, magnesium or mixtures thereof. Suitable neutral or over-based, metal-containing detergent additives are neutral or overbased calcium-containing detergents; neutral or over-based, magnesium-containing detergents and mixtures of one or more thereof. Suitable neutral or over-based, metal-containing detergent additives are phenates, sulphonates, salicylates, alkylsalicylates and mixtures of one or more thereof. Suitable neutral or over-based metal-containing detergent additives are neutral or over-based, calcium alkylsalicylates; neutral or over-based, calcium phenates; neutral or over-based, calcium sulphonates; neutral or over-based, magnesium salicylates and mixtures of one or more thereof.

The metal salt-containing detergent additives may be present in the lubricating oil composition at a total metal salt concentration in the lubricating oil composition of at least 0.15% by weight.

### The Dispersant Additives.

The nitrogen-containing dispersant additives in the lubricating oil composition may be polyisobutene succinic anhydride dispersants. The total amount of nitrogen in the dispersant additives in the lubricating oil composition may be 0.02 to 0.1% by weight nitrogen.

### Other Additives.

The lubricating oil composition may also comprise one or more of the following additives: viscosity modifiers, dispersant viscosity modifiers, antioxidants, anti-wear additives, pour point depressants, corrosion inhibitors, dyes and antifoams.

Suitable viscosity modifier additives are star polymers, styrenic polymers, linear polymers, olefin co-polymers (sometimes referred to as OCP's) and polyisobutene polymers. Suitable viscosity modifiers are available from Infineum (e.g. SV151 and SV261), Lubrizol and Afton.

The one or more viscosity modifier additives when present, may be present in the lubricating oil composition at a total concentration of up to 15% by weight and at a preferred concentration of up to 7% by weight.

Suitable dispersant viscosity modifier additives are dispersant olefin co-polymers (sometimes referred to as DOCP's). Dispersant viscosity modifier may comprise more than one oil soluble, polymeric hydrocarbon backbone each having one or more functional groups which are capable of associating with particles to be dispersed. Each functionalised polymeric hydrocarbon backbone may be functionalised with one or more functional groups incorporated into the backbone or with one or more functional groups pendant from the polymer backbone. Typical functional groups may be polar and may contain one or more hetero atoms, for example phosphorus, oxygen, sulphur, nitrogen, halogen or boron. An example of a suitable dispersant viscosity modifier is a co-polymer of ethylene-propylene grafted with an active monomer, for example maleic anhydride and then derivatized with an alcohol or amine. The preparation of such dispersant viscosity modifiers is described for example in U.S. Pat. No. 4,089,794, U.S. Pat. No. 4,160,739 and U.S. Pat. No. 4,137,185. Other dispersant viscosity modifiers which may be used are copolymers of ethylene or propylene reacted or grafted with nitrogen compounds, for example as described in U.S. Pat. No. 4,068,056, U.S. Pat. No. 4,068,058, U.S. Pat. No. 4,146,489 and U.S. Pat. No. 4,149,984. Other dispersant viscosity modifiers which may be used are graft copolymers, for example as described in WO96/12746 and WO 99/21902. Suitable dispersant viscosity modifiers include HiTEC 5777 available from Afton.

The one or more dispersant viscosity modifier additives when present, may be present in the lubricating oil composition at a total concentration of up to 15% by weight and at a preferred concentration up to 7% by weight.

One or more anti-oxidant additives may be present in the lubricating oil composition. Suitable anti-oxidants are for example, hindered phenols, alkaline earth metals salts of alkylphenolthioesters having preferably C₅ to C₁₂ alkyl side chains, calcium nonylphenol sulphide, calcium dodecylphenol sulphide, oil soluble phenates, oils soluble sulphurised phenates, phosphosulphurised hydrocarbons, sulphurised hydrocarbons (for example, sulphurised olefins), phosphorus esters, metal thiocarbamates, oil soluble copper compounds (for example, as described in U.S. Pat. No. 4,867,890), molybdenum-containing compounds and the like. The one or more anti-oxidants may be present in the lubricating oil composition in a total amount of up to 5% by weight of the lubricating oil composition, preferably up to 3% by weight, for example up to 1.5% by weight.

Suitable anti-wear additives are metal dihydrocarbyl dithiophosphates. These compounds may be used as anti-wear and/or antioxidant agents. Suitable metals in these compounds are for example, alkali metals, alkaline earth metals, zinc, aluminium, lead, tin, molybdenum, manganese, nickel and copper, most preferably zinc. Primary and/or secondary hydrocarbyl groups may be present in these compounds. Each hydrocarbyl group may have 1 to 18 carbon atoms. The one or more metal dihydrocarbyl dithiophosphates may be present in the lubricating oil composition in a total amount, expressed as phosphorus, of 0.01 to 0.2% by weight of the composition. The one or more anti-wear additives when present, may be present in the lubricating oil composition at a total concentration of up to 5% by weight, for example up to 2% by weight.

One or more pour point depressants may optionally be present in the lubricating oil composition. Suitable pour point depressants are for example, methacrylates, alkyl methacrylates, vinyl fumarates, styrene esters and the like. The one or more pour point depressants may be present in the lubricating oil composition in a total amount of up to 1% by weight of the lubricating oil composition, preferably up to 0.5% by weight, for example up to 0.3% by weight.

One or more corrosion inhibitors may optionally be present in the lubricating oil composition. Suitable corrosion inhibitors are for example, non-ionic polyoxyalkylene polyols and esters thereof, polyoxyalkylene phenols, triazoles, anionic alkyl sulphonic acids and the like. The one or more corrosion inhibitors may be present in the lubricating oil composition in a total amount of up to 1% by weight of the lubricating oil, composition.

One or more antifoaming agents may optionally be present in the lubricating oil composition. Suitable antifoaming agents are for example, siloxanes, dimethyl siloxanes, phenyl methyl siloxanes, acrylates and the like. The one or more anti-foaming agents may be present in the lubricating oil composition in a total amount by weight typically of 10 to 100 ppm of the lubricating oil composition.

One or more dyes may optionally be present in the lubricating oil composition.

### The Base Oil.

The base oil of the lubricating oil composition may be a Group I and/or a Group II base stock. The base oil of the lubricating oil composition may comprise a Group I and/or a Group II base stock with (i) greater than 0% and up to 30% by weight Group III base stock and/or with (ii) greater than 0% and up to 50% by weight Group V base stock. The base oil should not comprise any Group IV base stock.

Group I, II, III, IV and V base stocks are defined according to API standard 1509, “ENGINE OIL LICENSING AND CERTIFICATION SYSTEM”, November 2004 version 15th edition Appendix E, as set out in Table I below.

TABLE I

| | Saturated | | | | |
|---|---|---|---|---|---|
| | hydrocarbon content | | Sulphur content | | |
| Group | (wt %) | | (wt %) | | Viscosity Index |
| I | <90 | and/or | >0.03 | and | ≧80 and <120 |
| II | ≧90 | and | ≦0.03 | and | ≧80 and <120 |
| III | ≧90 | and | ≦0.03 | and | ≧120 |

| | |
|---|---|
| IV | polyalpha olefins |
| V | all base stocks not in Groups I, II, III or IV |

Group II basestocks include Group II+basestocks which are Group II basestocks with a viscosity index of 110 to 120.

Group I, Group II and Group III base stocks are derived from mineral oils, by known processes which comprise hydrocracking and/or hydroisomerisation. A suitable Group I base stock is APE 150SN. Suitable Group II basestocks are Jurong 150SN, Jurong 500SN and mixtures thereof. A suitable Group III base stock is Yubase 6. Suitable Group V base stocks are ester base stocks, for example Priolube 3970. APE and Jurong basestocks are available from Exxon Mobil and Yubase basestocks are available from SK.

The lubricating oil composition of the present invention may be a multi-grade lubricating oil composition according to the API classification xWy where x is 0, 5, 10, 15 or 20 and y is 30, 40 50 or 60 as defined by SAE J300 1999.

The lubricating oil composition may be used in a compression ignition, internal combustion engine.

The lubricating oil composition may be prepared by blending appropriate components together by methods known in the art. The additives may be combined together in one or more additive concentrates or part additive package concentrates, optionally comprising solvent or diluent.

### The Fuel.

The aqueous ethanol fuel comprises 70 to 96% by weight ethanol, 10 to 2% by weight water and up to 20% by weight ignition improver. The ignition improver additives may be present in a total concentration of 0.5 to 20% by weight. A suitable type of ignition improver additive is a water soluble adduct of a polyol having 3-10 hydroxyl groups and ethylene oxide and/or propylene oxide, wherein the molecular weight of the adduct is 350 to 10000. Suitable ignition improver additives are described for example, in U.S. Pat. No. 5,628,805. Suitable ignition improvers include glycerol ethoxylate, trimethylolpropane ethoxylate, di(trimethylolpropane) ethoxylate sorbitol ethoxylate and pentaerythritol ethoxylate.

The ethanol may be derived from renewable sources, for example the ethanol may be bioethanol.

The aqueous ethanol fuel may also comprise a number of conventional additives, for example corrosion inhibitors, lubrication-improving agents and denaturants.

The aqueous ethanol fuel may comprise one or more denaturant. Suitable denaturants include methyl tert-butyl ether, isobutanol and methanol. Methyl tert-butyl ether may be present at a concentration of up to 3% by weight, for example at a concentration of 2.3% by weight. Iso-butanol may be present at a concentration of up to 1% by weight, for example at a concentration of 0.5% by weight. Methanol may be present in the aqueous ethanol fuel at up to 3% by weight.

The aqueous ethanol fuel may comprise one or more corrosion inhibitors. A typical concentration of corrosion inhibitor is 90 ppm by weight.

The aqueous ethanol may comprise one or more dye. Suitable dyes include red dye.

Suitable aqueous ethanol fuels include Etamax-D (trade mark) which is bio-ethanol fuel comprising minor amounts of an ignition improver, denaturant, corrosion inhibitor and dye. The sales specification for Etamax-D is 92.2% by weight of 95% ethanol, 5.0% by weight ignition improver, denaturants (2.3% by weight methyl tert-butyl ether and 0.5% by weight iso-butanol) and 90 ppm corrosion inhibitor. Etamax-D is red in colour and is available from Sekab (Svensk Etanolkemi AB).

### The Compression Ignition Internal Combustion Engine.

The compression ignition engine may be a conventional diesel engine. The engine may operate with at a high compression ratio and/or with preheating of the inlet air. According to U.S. Pat. No. 5,628,805, an aqueous ethanol fuel for such engines normally contains 0.5 to 10%, preferably from 1 to 8% by weight ignition improver, while other diesel engines may require higher amounts.

According to a further aspect of the present invention there is provided a lubricating oil composition as hereindefined which has a total sulphur content of up to 0.44% by weight. Such a lubricating oil composition has a total sulphur content of not greater than 0.44% by weight. Such a lubricating oil will meet the sulphur concentration limits of international standards (1) ACEA 2008 European Oil Sequence For Service-fill Oils For Heavy Duty Diesel Engines E9-08 which specifies a sulphur limit measured according to ASTM D5185 of less than or equal to 0.4% by weight and (2) API CJ-4 which specifies a maximum permitted sulphur concentration measured according to D4951 of 0.4% by weight. Such low sulphur concentrations may be achieved for example by appropriate selection of the base oil and/or by the use of sulphur-free antioxidants. An advantage of such a lubricating oil composition is that the low sulphur concentration reduces the impact of the exhaust emissions from the engine on any after treatment devices. Such a lubricating oil composition is suitable for use in the method of the present invention.

The invention will now be described by way of example only with reference to the following Examples 1-3 and Experiment A.

### EXAMPLE 1

A 10W40 lubricating oil composition was prepared by blending appropriate components together to have the following composition.

### EXAMPLE 1

Ratio of nitrogen in dispersant to metal salt=0.225:1.

| Component | Amount (% by weight) |
|---|---|
| Jurong 150SN Group II base oil | 56.95 |
| Jurong 500SN Group II base oil | 28.8 |
| Detergent in solvent | 1.05 (corresponding to |
| | approx 0.2% metal salt) |
| Dispersant in solvent | 5 (corresponding to |
| | approximate 0.045% nitrogen) |
| ZDDP anti-wear additive | 1 |
| Anti-oxidants | 1 |
| Viscosity modifier in solvent | 6 |
| Pour point depressant in solvent | 0.2 |

### EXAMPLE 2

A lubricating oil composition was prepared by blending appropriate components together to have the following composition.

### EXAMPLE 2

| Component | Amount (% by weight) |
|---|---|
| APE 150SN Group I base oil | 74.25 |
| Yubase 6 Group III base oil | 10 |
| Detergent in solvent | 1.05 (corresponding to |
| | approx 0.2% metal salt) |
| Dispersant in solvent | 5 (corresponding to |
| | approximate 0.045% nitrogen) |
| ZDDP anti-wear additive | 1 |
| Anti-oxidants | 1 |
| Viscosity modifier in solvent | 7.5 |
| Pour point depressant in solvent | 0.2 |

The compatibility of the lubricating oil formulations of Examples 1 and 2 with aqueous ethanol fuel (Etamax D) was determined using the following protocol:
1. Mix (95% by weight) lubricant with 5% by weight fuel (Etamax-D) in small vial (100 ml or more typically, 15 grams);
2. Shake vigorously for one minute until the two fluids are completely mixed;
3. Store in a ventilated cabinet at room temperature;
4. Inspect (visually) samples after one week for signs of deposits/compatibility performance.

For both Examples 1 and 2, no significant deposits were observed after at least 1 week at room temperature.

These results indicate that the lubricating oil compositions could be used in a method of operating a compression ignition engine which method comprises supplying an aqueous ethanol fuel comprising 70 to 96% by weight ethanol, 10 to 2% by weight water and up to 20% by weight ignition improver to the engine and lubricating the engine with the lubricating oil composition.

### EXAMPLE 3

A lubricating oil composition was prepared using 2% by weight of a calcium sulphonate detergent additive composition with total base number of 400 mg potassium hydroxide per kg, 5% by weight of ashless dispersant and 1% by weight of ZDDP anti-wear agent with 92% by weight 150N base oil. This lubricating oil composition had a total metal salt concentration in the lubricating oil composition of greater than 0 and up to 1% by weight and a weight ratio of the total amount of nitrogen in the dispersant additives:the total amount of metal salt in the detergent additives of, at least 0.1:1. No significant deposits were observed after at least 1 week at room temperature using the test protocol described above.

### EXPERIMENT A

A lubricating oil composition was prepared using 2% by weight of a calcium sulphonate detergent additive composition with total base number of 400 mg potassium hydroxide per kg, 1% by weight of ashless dispersant and 1% by weight of ZDDP anti-wear agent with 96% by weight 150N base oil. This lubricating oil composition had a total metal salt concentration in the lubricating oil composition of greater than 0 and up to 1% by weight but a weight ratio of the total amount of nitrogen in the dispersant additives:the total amount of metal salt in the detergent additives of, less than 0.1:1. Deposits were observed after a week at room temperature using the test protocol described above. This is not an example according to the present invention because the weight ratio of the total amount of nitrogen in the dispersant additives:the total amount of metal salt in the detergent additives is less than 0.1:1.

This shows that the weight ratio of the total amount of nitrogen in the dispersant additives:the total amount of metal salt in the detergent additives being at least 0.1 to 1 provides a lubricating oil composition with decreased incompatibility with aqueous ethanol fuel comprising 70 to 96% by weight ethanol, 10 to 2% by weight water and up to 20% by weight ignition improver. These results indicate that such a lubricating oil composition could be used beneficially in a method of operating a compression ignition engine which method comprises supplying an aqueous ethanol fuel comprising 70 to 96% by weight ethanol, 10 to 2% by weight water and up to 20% by weight ignition improver to the engine and lubricating the engine with the lubricating oil composition.

The total sulphur contents of the lubricants in Examples 1 to 3 and in Experiment A were estimated by calculation to be not greater than 0.44% by weight.

1.-18. (canceled)

19. A method of operating a compression ignition engine, which method comprises supplying an aqueous ethanol fuel comprising 70 to 96% by weight ethanol, 10 to 2% by weight water and up to 20% by weight ignition improver to the engine and lubricating the engine with a lubricating oil composition which comprises a major amount of a base oil of lubricating viscosity and a minor amount of additives comprising one or more nitrogen-containing dispersant additives and one or more neutral or over-based, metal salt-containing detergent additives, the metal salt-containing detergent additives being present in the lubricating oil composition at a total metal salt concentration in the lubricating oil composition of greater than 0 and up to 1% by weight and the weight ratio of the total amount of nitrogen in the dispersant additives the total amount of metal salt in the detergent additives being, at least 0.1:1.

20. A method as claimed in claim 19 in which the weight ratio of the total amount of nitrogen in the dispersant additives:the total amount of metal salt in the detergent additives is at least 0.2:1.

21. A method as claimed in claim 19 in which the weight ratio of the total amount of nitrogen in the dispersant additives:the total amount of metal salt in the detergent additives is up to 1:1.

22. A method as claimed in claim 20 in which the weight ratio of the total amount of nitrogen in the dispersant additives:the total amount of metal salt in the detergent additives is up to 1:1.

23. A method as claimed in claim 19 in which the over-based metal salt-containing detergent additives have a TBN in the range 100-400 mg potassium hydroxide per kg.

24. A method as claimed in claim 22 in which the over-based metal salt-containing detergent additives have a TBN in the range 100-400 mg potassium hydroxide per kg.

25. A method as claimed in claim 19 in which the metal of the over-based metal salt-containing detergent additives is calcium, magnesium or mixtures thereof.

26. A method as claimed in claim 24 in which the metal of the over-based metal salt-containing detergent additives is calcium, magnesium or mixtures thereof.

27. A method as claimed in claim 19 in which the neutral or over-based, metal salt-containing detergent additives are phenates, sulphonates, salicylates, alkylsalicylates or mixtures of one or more thereof.

28. A method as claimed in claim 26 in which the neutral or over-based, metal salt-containing detergent additives are phenates, sulphonates, salicylates, alkylsalicylates or mixtures of one or more thereof.

29. A method as claimed in claim 1.9 in which the nitrogen-containing dispersant additives in the lubricating oil composition are polyisobutene succinic anhydride dispersants.

30. A method as claimed in claim 28 in which the nitrogen-containing dispersant additives in the lubricating oil composition are polyisobutene succinic anhydride dispersants.

31. A method as claimed in claim 19 in which the total amount of nitrogen in the dispersant additives in the lubricating oil composition is 0.02 to 0.1% by weight nitrogen.

32. A method as claimed in claim 30 in which the total amount of nitrogen in the dispersant additives in the lubricating oil composition is 0.02 to 0.1% by weight nitrogen.

33. A method as claimed in claim 19 in which the lubricating oil composition further comprises one or more of the following additives: viscosity modifiers, dispersant viscosity modifiers, antioxidants, anti-wear additives, pour point depressants, corrosion inhibitors, dyes and antifoams.

34. A method as claimed in claim 32 in which the lubricating oil composition further comprises one or more of the following additives: viscosity modifiers, dispersant viscosity modifiers, antioxidants, anti-wear additives, pour point depressants, corrosion inhibitors, dyes and antifoams.

35. A method as claimed in claim 19 in which the base oil of the lubricating oil composition is either a Group I and/or a Group II base stock or a Group I and/or a Group II base stock with (i) greater than 0% and up to 30% by weight Group III base stock and/or with (ii) greater than 0% and up to 50% by weight Group V base stock.

36. A method as claimed in claim 34 in which the base oil of the lubricating oil composition is either a Group I and/or a Group II base stock or a Group I and/or a Group II base stock with (i) greater than 0% and up to 30% by weight Group III base stock and/or with (ii) greater than 0% and up to 50% by weight Group V base stock.

37. A method as claimed in claim 19 in which the ignition improver additives are present in the aqueous ethanol fuel at a total concentration of 0.5 to 20% by weight.

38. A method as claimed in claim 36 in which the ignition improver additives are present in the aqueous ethanol fuel at a total concentration of 0.5 to 20% by weight.

39. A method as claimed in claim 19 in which the ignition improver additive is a water soluble adduct of a polyol having 3-10 hydroxyl groups and ethylene oxide and/or propylene oxide, wherein the molecular weight of the adduct is 350 to 10000.

40. A method as claimed in claim 38 in which the ignition improver additive is a water soluble adduct of a polyol having 3-10 hydroxyl groups and ethylene oxide and/or propylene oxide, wherein the molecular weight of the adduct is 350 to 10000.

41. A method as claimed in claim 19 in which the ignition improver additive is selected from glycerol ethoxylate, trimethylolpropane ethoxylate, di(trimethylolpropane) ethoxylate sorbitol ethoxylate, pentaerythritol ethoxylate and mixtures thereof.

42. A method as claimed in claim 38 in which the ignition improver additive is selected from glycerol ethoxylate, trimethylolpropane ethoxylate, di(trimethylolpropane) ethoxylate sorbitol ethoxylate, pentaerythritol ethoxylate and mixtures thereof.

43. A method as claimed in claim 19 in which the aqueous ethanol fuel further comprises one or more additives selected from the group consisting of corrosion inhibitors, lubrication-improving agents, denaturants and mixtures thereof.

44. A method as claimed in claim 40 in which the aqueous ethanol fuel further comprises one or more additives selected from the group consisting of corrosion inhibitors, lubrication-improving agents, denaturants and mixtures thereof.

45. A method as claimed in claim 19 in which the aqueous ethanol fuel consists of 92.2% by weight of 95% ethanol, 5.0% by weight ignition improver, 2.3% by weight methyl tert-butyl ether, 0.5% by weight iso-butanol, 90 ppm corrosion inhibitor and red dye.

46. A lubricating oil composition which is a lubricating oil composition as defined in claim 19 having a total sulphur content of up to 0.44% by weight.

47. A lubricating oil composition which is a lubricating oil composition as defined in claim 21 having a total sulphur content of up to 0.44% by weight.
